(19) United States
(12) Patent Application Publication
(10) Pub. No.: US 2009/0113479 A1
(43) Pub. Date: Apr. 30, 2009

(54) PROGRAM TABLE DISPLAY DEVICE, PROGRAM TABLE DISPLAY METHOD, AND BROADCAST RECEIVING APPARATUS

(75) Inventor: Go Tomita, Fukaya-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/238,292

(22) Filed: Sep. 25, 2008

(30) Foreign Application Priority Data
Oct. 31, 2007 (JP) 2007-283846

(51) Int. Cl. H04N 5/445

(52) U.S. Cl. 725/44

(57) ABSTRACT

According to one embodiment, in creating an electronic program table having a channel axis along which a plurality of broadcasting stations are arranged in one direction and a time axis arranged in a direction orthogonal to the channel axis, an area shown by the channel axis and the time axis corresponding to a display area for the program information, the plurality of broadcasting stations arranged along the channel axis are placed in an order based on a pre-standardized order of companies.

### CROSS-REFERENCE TO RELATED APPLICATIONS

This application is based upon and claims the benefit of priority from Japanese Patent Application No. 2007-283846, filed Oct. 31, 2007, the entire contents of which are incorporated herein by reference.

### BACKGROUND

1. Field

One embodiment of the invention relates to a program table display device, a program table display method, and a broadcast receiving apparatus which are suitably used for, for example, a digital television broadcast receiving apparatus.

2. Description of the Related Art

As is well-known, digitalization of television broadcasting has recently been promoted. For example, in Japan, not only digital broadcasting such as digital direct broadcasting by satellite (DBS) but also terrestrial digital broadcasting has begun.

Digital television broadcast receiving apparatuses receiving such digital television broadcasting create an electronic program table on the basis of electronic program guide (EPG) information acquired from broadcast signals to display corresponding videos on a screen. Thus, users can select a desired program from the electronic program table displayed as the video to view the program or to set the digital television broadcast receiving apparatus to automatically record the program.

In digital television broadcasting, the EPG information contains information allowing an electronic program table for the next seven days to be created for each of a large number of broadcast channels. Furthermore, in radio broadcasting, the EPG information contains information allowing an electronic program table for the next three days to be created for each broadcast channel.

Thus, the digital television broadcast receiving apparatus cannot simultaneously display all of the electronic program table on a limited screen. The user thus partly switches the electronic program table displayed on the screen. In this case, the user allows a desired part of the electronic program table to be displayed by performing a scroll operation, a page switching operation, and the like on the screen.

Here, in the digital television receiving apparatus of this kind, the electronic program table is displayed on the basis of the user's display request operation. Currently, when the display request operation for the electronic program table is performed, the contents of the electronic program table are displayed using the currently selected channel or program as a start point.

For example, a display form has been adopted in which the currently selected channel is located in a central portion of the screen or a program being viewed is located at a preset position on the electronic program table. However, neither display form is perfect in terms of the easiness with which the user sees and understands the electronic program table on the screen.

Jpn. Pat. Appln. KOKAI Publication No. 7-193762 discloses a program display device that allows a plurality of channels to be simultaneously displayed on the program table so that the user can view the contents of the corresponding programs at a time. The program display device also sets the same program time for the displayed channels to allow the user to have the same feeling as that the user has when reading TV listings in an ordinary newspaper, while improving visibility.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a diagram showing an embodiment of the present invention and schematically illustrating a digital television receiving apparatus and an example of a network system constructed around the digital television receiving apparatus;

FIG. 2 is a block diagram illustrating a main signal processing system in the digital television broadcast receiving apparatus according to the embodiment;

FIG. 3 is a diagram illustrating the appearance of a remove controller for the digital television broadcast receiving apparatus;

FIG. 4 is a diagram illustrating an example of a display form of an electronic program table displayed by the digital television broadcast receiving apparatus according to the embodiment;

FIG. 5 is a diagram illustrating another example of the display form of the electronic program table displayed by the digital television broadcast receiving apparatus according to the embodiment;

FIG. 6 is a diagram illustrating yet another example of the display form of the electronic program table displayed by the digital television broadcast receiving apparatus according to the embodiment;

FIG. 7 is a diagram illustrating still another example of the display form of the electronic program table displayed by the digital television broadcast receiving apparatus according to the embodiment;

FIG. 8 is a flowchart illustrating a process operation of creating an electronic program table which operation is performed by the digital television broadcast receiving apparatus according to the embodiment; and

FIG. 9 is a diagram illustrating an example of a display form selection screen displayed by the digital television broadcast receiving apparatus according to the embodiment.

### DETAILED DESCRIPTION

Various embodiments according to the invention will be described hereinafter with reference to the accompanying drawings. In general, according to one embodiment of the invention, in creating an electronic program table having a channel axis along which a plurality of broadcasting stations are arranged in one direction and a time axis arranged in a direction orthogonal to the channel axis, an area shown by the channel axis and the time axis corresponding to a display area for the program information, the plurality of broadcasting stations arranged along the channel axis are placed in an order based on a pre-standardized order of companies.

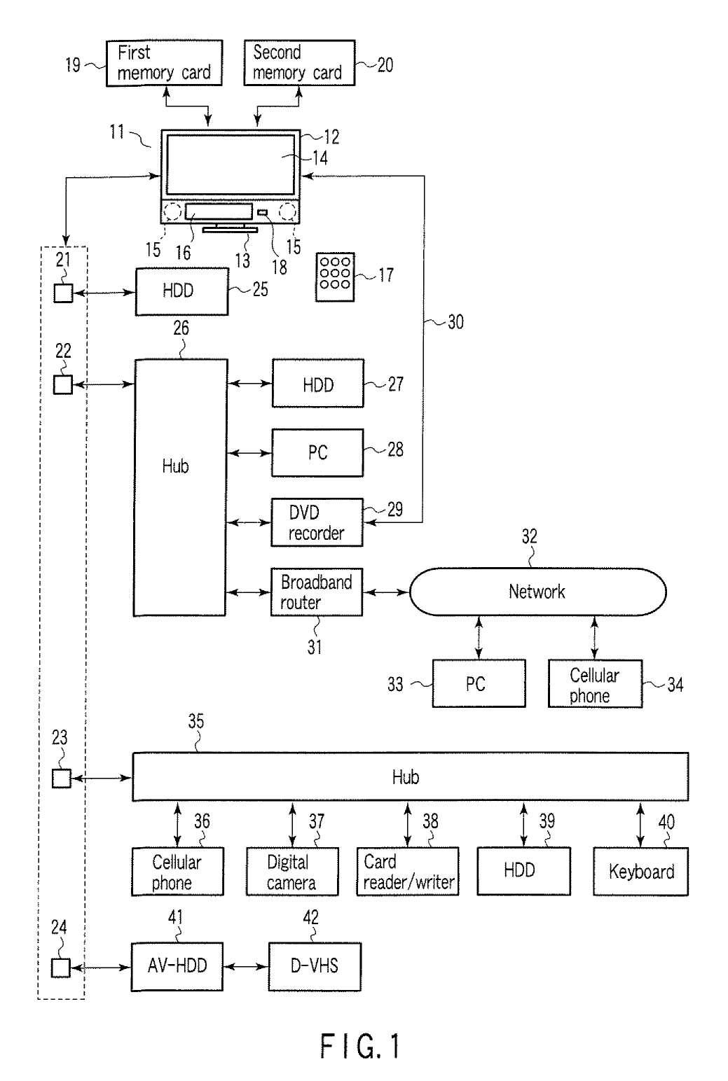

An embodiment of the present invention will be described below with reference to the drawings. FIG. 1 schematically shows the appearance of a digital television broadcast receiving apparatus 11 described in the embodiment and an example of a network system constructed around the digital television broadcast receiving apparatus 11.

That is, the digital television broadcast receiving apparatus 11 is composed of a thin cabinet 12 and a support table 13 that support the cabinet 12 upright. A video display 14, a pair of speakers 15, an operation module 16, a light receiving module 18, and the like are installed in the cabinet 12; the video display 14 is a planar panel display comprising, for example, a liquid crystal display panel, and the light receiving module 18 receives operation information transmitted by a remote controller 17.

A first memory card 19, for example, an SD (Secure Digital) memory card, an MMC (MultiMedia Card), or a memory stick can be installed in and removed from the digital television broadcast receiving apparatus 11. Information on programs, photographs, or the like is recorded on and reproduced from the first memory card 19.

Moreover, a second memory card [IC (Integrated Circuit) card] 20 on which, for example, contract information is recorded can be installed in and removed from the digital television broadcast receiving apparatus 11. The contract information is reproduced from the second memory card 20.

The digital television broadcast receiving apparatus 11 also comprises a first LAN (Local Area Network) terminal 21, a second LAN terminal 22, a USS terminal (Universal Serial Bus) terminal 23, and an IEEE (Institute of Electrical and Electronics Engineers) 1394 terminal 24.

Among these terminals, the first LAN terminal 21 is used as a dedicated port for a LAN-compatible HDD to record and reproduce information on and from a LAN-compatible HDD (Hard Disk Drive) 25 on the basis of Ethernet (registered trade mark); the LAN-compatible HDD 25 is a connected NAS (Network Attached Storage)

By thus providing the first LAN terminal 21, serving as a dedicated port for a LAN-compatible HDD, information on programs of high vision image quality can be stably recorded on HDD 25 without being affected by another network environment, network use conditions, or the like.

Furthermore, the second LAN terminal 22 is used as a common LAN-compatible port using Ethernet (registered trade mark). For example, the second LAN terminal 22 connects via, for example, a hub 26 to equipment such as a LAN-compatible HDD 27, PC (Personal Computer) 28, a DVD (Digital Versatile Disk) recorder 29 having a built-in HDD and a digital broadcast receiving function to transmit and receive information to and from the equipment.

For the DVD recorder 29, digital information communicated via the second LAN terminal 22 is information for a control system. Thus, a dedicated analog transmission path 30 needs to be provided in order to transmit and receive analog video and audio information to and from the digital television broadcast receiving apparatus 11.

Moreover, the second LAN terminal 22 can be connected to a network 32, for example, the Internet, via a broadband router 31 connected to a hub 26. The second LAN terminal 22 is thus used to transmit and receive information to and from various information terminals such as PC 33 and a cellular phone 34 via the network 32.

The USB terminal 23 is used as a common USB-compatible port. The USB terminal 23 connects via, for example, a hub 35 to USB equipment such as a cellular phone 36, a digital camera 37, a card reader/writer 38 for a memory card, HDD 39, or a keyboard 40. The USB terminal 23 is thus used to transmit and receive information to and from the USB equipment.

For example, AV (Audio Video)-HDD 41 or D (Digital)-VHS (Video Home System) 42 which has a digital broadcast receiving function is serially connected to the IEEE 1394 terminal 24. The IEEE 1394 terminal 24 is thus used to transmit and receive information to and from this equipment.

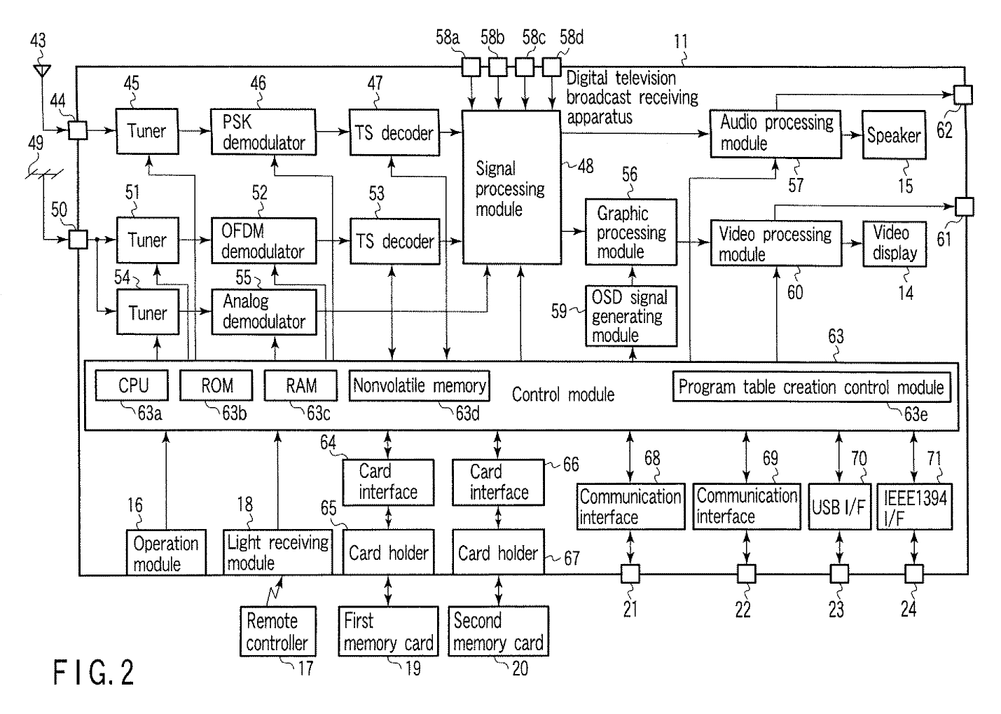

FIG. 2 shows a main signal processing system in the above-described digital television broadcast receiving apparatus 11. That is, a satellite digital broadcast signal received through a digital DBS receiving antenna 43 is supplied to a digital DBS tuner 45 via an input terminal 44 to select a broadcast signal on a desired channel.

The broadcast signal selected by the tuner 45 is supplied to a PSK (Phase Shift Keying) demodulator 46 to demodulate TS (Transport Stream). TS is supplied to a TS decoder 47, which decodes TS into a digital video signal, a digital audio signal, and the like. The resulting signals are output to a signal processing module 48.

A terrestrial digital television broadcast signal received through a terrestrial broadcast receiving antenna 49 is supplied to a terrestrial digital broadcast tuner 51 via an input terminal 50 to select the broadcast signal on the desired channel.

The broadcast signal selected by the tuner 51 is supplied to an OFDM (Orthogonal Frequency Division Multiplexing) demodulator 52 to demodulate TS. TS is supplied to a TS decoder 53, which decodes TS into a digital video signal, a digital audio signal, and the like. The resulting signals are output to a signal processing module 48.

A terrestrial analog television broadcast signal received through the terrestrial broadcast receiving antenna 49 is supplied to a terrestrial analog broadcast tuner 54 via the input terminal 50 to select the broadcast signal on the desired channel. The broadcast signal selected by the tuner 54 is supplied to an analog demodulator 55, which decodes the signal into an analog video signal, an analog audio signal, and the like. The resulting signals are output to the signal processing module 48.

Here, the signal processing module 48 selectively executes predetermined digital signal processing on the digital video signals and audio signals supplied by the TS decoders 47 and 53 and outputs the processed signals to a graphic processing module 56 and a audio processing module 57.

A plurality of (in the illustrated case, four) input terminals 58a, 58b, 58c, and 58d are connected to the signal processing module 48. Analog video and audio signals from equipment located outside the digital television broadcast receiving apparatus 11 can be input to the input terminals 58a to 58d.

The signal processing module 48 selectively digitalizes the analog video and audio signals supplied by the analog demodulator 55 and the input terminals 58a to 58d. The signal processing module 48 then executes predetermined digital signal processing on the digitalized video and audio signals and outputs the resulting signals to the graphic processing module 56 and the audio processing module 57.

The graphic processing module 56 has a function of superimposing an OSD signal generated by an on-screen display (OSD) signal generating module 59, on the digital video signal supplied by the signal processing module 48. Furthermore, the graphic processing module 56 can selectively output the output video signal from the signal processing module 48 and the output OS signal from the OSD signal generating module 59 and combine the two signals together so that each of the signals constitutes half of the screen and output the combined signals.

The digital video signal output by the graphic processing module 56 is supplied to a video processing module 60. The video processing module 60 converts the input digital video signal into an analog video signal in a format in which the signal can be displayed by the video display 14. The video processing module 60 then outputs the analog video signal to the video display 14 for video display and provides the signal to external equipment via an output terminal 61.

The audio processing module 57 converts the input digital audio signal into an analog audio signal in a format in which the signal can be reproduced by the speaker 15. The audio processing module 57 then outputs the signal to the speaker 15 for audio reproduction and provides the signal to external equipment via an output terminal 62.

All operations of the digital television broadcast receiving apparatus 11 including the above-described various receiving operations are integrally controlled by a control module 63. The control module 63 has a built-in CPU (Central Processing Unit) 63a to receive operation information from the operation module 16 or operation information transmitted by the remote controller 17 and received by the light receiving module 18 to control appropriate modules so as to reflect the contents of the operation.

In this case, the control module 63 mainly utilizes ROM (Read Only Memory) 63b that stores control programs to be executed by CPU 63a, RAM (Random Access Memory) 63c that provides a work area for CPU 63a, and a nonvolatile memory 63d that stores various pieces of setting information and control information.

The control module 63 is connected, via a card I/F (InterFace) 64, to a card holder 65 in which the first memory card 19 can be installed. The control module 63 can thus transmit and receive information, via the card I/F 64, to and from the first memory card 19 installed in the card holder 65.

The control module 63 is further connected, via a card I/F 66, to a card holder 67 in which the second memory card 20 can be installed. The control module 63 can thus transmit and receive information, via the card I/F 66, to and from the second memory card 20 installed in the card holder 67.

The control module 63 is further connected to the first LAN terminal 21 via a communication I/F 68. Thus, the control module 63 can transmit and receive information, via the communication I/F 68, to and from the LAN-compatible HDD 25 connected to the first LAN terminal 21. In this case, the control module 63 has a DHCP (Dynamic Host Configuration Protocol) server function and controls the LAN-compatible HDD 25 connected to the first LAN terminal 21, by assigning an IP (Internet Protocol) address to the LAN-compatible HDD 25.

The control module 63 is further connected to the second LAN terminal 22 via a communication I/F 69. The control module 63 can thus transmit and receive information, via the communication I/F 69, to and from the equipment (see FIG. 1) connected to the second LAN terminal 22.

The control module 63 is further connected to the USB terminal 23 via USB I/F 70. The control module 63 can thus transmit and receive information, via the USB I/F 70, to and from the equipment (see FIG. 1) connected to the USB terminal 23.

The control module 63 is further connected to the IEEE 1394 terminal 24 via IEEE 1394 I/F 71. The control module 63 can thus transmit and receive information, via the IEEE 1394 I/F 71, to and from the equipment (see FIG. 1) connected to the IEEE 1394 terminal 24.

The control module 63 comprises a program table creation control module 63e. The program table creation control module 63e creates an electronic program table displayed on the video display 14. In particular, the program table creation control module 63e has a function of setting the contents of an electronic program table displayed on the basis of a display request, in a preset predetermined display form regardless of the currently selected channel or program, achieving program display such that the user can easily understand the contents of the electronic program table; this will be described below in detail.

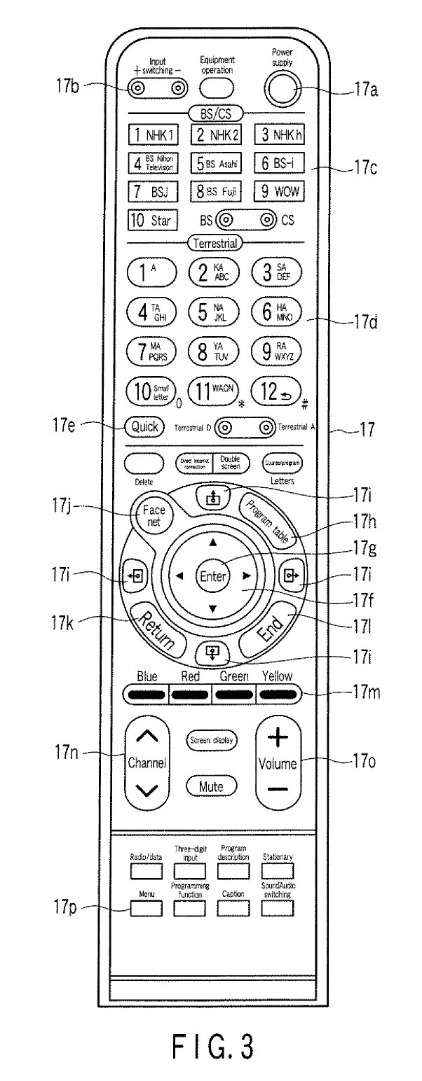

FIG. 3 shows the appearance of the remote controller 17. The remote controller 17 mainly has a power supply key 17a, an input switching key 17b, a direct selection key 17c for satellite digital broadcast channels, a direct selection key 17d for terrestrial broadcast channels, a quick key 17e, a cursor key 17f, an enter key 17g, a program table key 17h, a page switching key 17i, a face net (navigation) key 17j, a return key 17k, an end key 17l, a blue color key, a red color key, a green color key, and a yellow color key 17m, a channel up down key 17n, a volume adjustment key 17o, and a menu key 17p.

With the digital television broadcast receiving apparatus 11 the user can operate the program table key 17h on the remote controller 17 to display an electronic program table created by the program table creation control module 63e, on the display 14. The electronic program table is pre-created on the basis of broadcast signals or EPG information that is program information acquired via the network or the like.

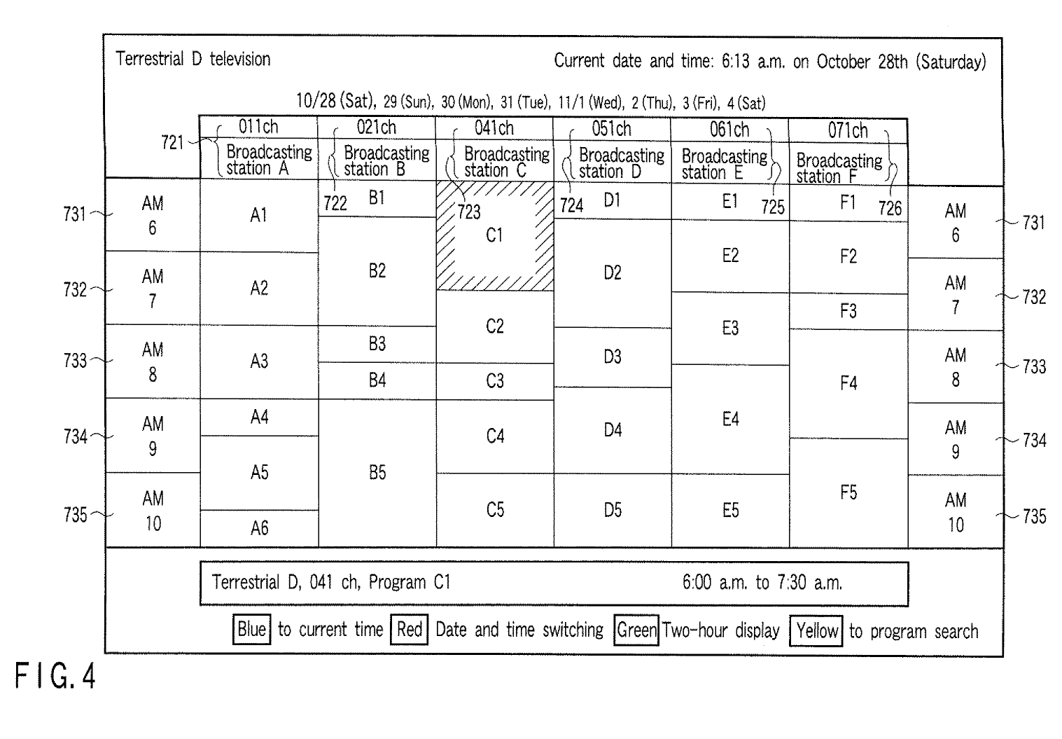

FIG. 4 shows an example of the display form of an electronic program table displayed on the video display 14 when the user operates the program table key 17h on the remote controller 17. The electronic program table shows programs on the basis of a channel axis extending in a horizontal direction and along which a plurality of (in the figure, six) broadcasting stations (channels) are arranged and a time axis extending in a vertical direction and corresponding to a time range for several hours (in the figure, five hours).

That is, the electronic program table has a plurality of (in the figure, six) channel display frames 721 to 726 arranged in the direction of the channel axis to display broadcasting station (broadcasting company) names and their channel numbers. In FIG. 4, broadcasting stations (broadcasting companies) A, B, C, D, E, and F and their channel numbers 011, 021, 041, 051, 061, and 071 are correspondingly displayed in the channel display frames 721 to 726 in this order from left to right in the figure.

The electronic program table has, in the direction of the time axis, a plurality of time frames 731 to 735 (in the figure, for five hours) displaying unit times (in the figure, the unit time corresponds to one hour) that are consecutive along the time sequence. In FIG. 4, the time frames 731 to 735 display five hours including 6 a.m., 7 a.m., 8 a.m., 9 a.m., and 10 a.m. in this order from the top to bottom of the figure.

Information on programs A1 to A6, B1 to B5, C1 to C5, D1 to D5, E1 to ES, and F1 to F5 scheduled by broadcasting stations A, B, C, D, and E is displayed in corresponding areas specified by channel display frames 721 to 726 and the time frames 731 to 735.

The electronic program table has, in its upper part in the figure, a display “terrestrial D television” indicating that the type of currently received broadcast is a terrestrial digital television broadcast, a display “current date and time: 6:13 a.m. on October 28th (Saturday)” indicating that the current date and time is 6:13 a.m. on Saturday 28th of October, and a display indicating the range of displayable days (days of the week) on the electronic program table.

That is, since the current date and time is 6:13 a.m. on October 28th (Saturday), the created electronic program table shows the programs from 6 a.m. on October 28th (Saturday) to 6 a.m. on November 4th (Saturday), seven days after October 28th. The range of the displayable days (days of the week) on the electronic program table includes the current day (day of the week) and seven days (days of the week) from the current day, that is, a total of eight days including October 28th (Saturday), October 29th (Sunday), October 30th (Monday), October 31st (Tuesday), November 1st (Wednesday), November 2nd (Thursday), November 3rd (Friday), and November 4th (Saturday), which are sequentially arranged in the electronic program table. In this case, text [October 28th (Saturday)] indicating the currently displayed day (day of the week) on the electronic program table is displayed larger than text indicating the other days (days of the week).

Furthermore, the electronic program table displays, in its lower part in the figure, the type of broadcast (terrestrial D), a channel number (041 ch), a program name (C1), broadcast time (6:00 a.m. to 7:30 am.), and the like. In this case, for the currently selected program C1, the corresponding display area in the electronic program table is displayed in a color different from that of the display areas for the other programs as indicated by a cursor. Tn FIG. 4, the display area for the currently selected program is hatched.

The electronic program table also displays, in its lower part in the figure, functions corresponding to the colors (blue, red, green, and yellow) of the color keys 17m on the remote controller 17 and each provided when the appropriate color key 17m is operated.

The electronic program table can be selectively scrolled upward, downward, rightward, and leftward by operating the cursor key 17f on the remote controller 17. The page switching key 17i on the remote controller 17 enables the electronic program table to be selectively skipped upward, downward, rightward, and leftward in screen units.

In this case, scrolling and skipping in the direction of the time axis changes the times displayed in the time frames 731 to 735 and the program information corresponding to the times to the times and program information resulting from the movement. Scrolling and skipping in the direction of the channel axis changes the broadcasting stations and channels displayed in the channel display frames 721 to 726 and the program information corresponding to the broadcasting stations and channels to the broadcasting stations and channels as well as the program information resulting from the movement.

Now, a display form will be described which is characteristic of the electronic program table displayed on the video display 14 when the user operates the program table key 17h on the remote controller 17. That is, when the program table key 17h on the remote controller 17, the program table creation control module 63e functions to create and display an electronic program table that uses one of the available broadcasting stations which has the smallest company identification number as well as the current date and time as start points regardless of the currently selected channel or program.

Specifically, when the program table key 17h on the remote controller 17 is operated, the program table creation control module 63e sequentially assigns the available broadcasting stations to the channel display frames 721 to 726 in order of increasing company identification number, that is, from A to F. For the date and time, the current date and time, that is, 6 a.m. on October 28th is assigned to the uppermost time frame 731 in the figure.

Thus, when the user operates the program table key 17h on the remote controller 17 to request display of the electronic program table, the electronic program table displayed on the video display 14 is set in the display form in which the electronic program table uses one of the available broadcasting stations which has the smallest company identification number as well as the current date and time as start points regardless of the currently selected channel or program

In this case, the program table creation control module 63e recognizes the company identification number on the basis of data sent by the signal processing module 48. The term “company identification number” as used herein refers to, in Japan, and “local business identification” described in TR (Technical Report)-B14, Seventh Edition, Chapter 9 specified as standards for terrestrial digital broadcasting by “the Center of Promotion of Efficient Use of the Radio Spectrum” designated by the Minister of Public Management and Association of Radio Industries and Businesses simply referred to as ARIB and which is the “Designated Frequency Support Agency”. Arranging the broadcasting stations in the order based on the standards allows the electronic program table to be always displayed in a display form similar to that of TV listings in a newspaper, a magazine, and the like when display of the electronic program table is requested.

That is, regardless of which program has been selected by the user, a request for display of the electronic program table allows the electronic program table to be always displayed with the broadcasting stations arranged in the same order. Thus, since the electronic program table is displayed in a display form similar to that of TV listings in a newspaper, a magazine, and the like, the user can easily determine the direction in which scrolling or skipping is to be performed in order to search for another channel or program. This results in program display that is easy for the user to understand.

In this connection, the conventional electronic program table is displayed in a form using the currently selected channel or program as a start point when display of the electronic program table is requested. Consequently, when searching for another channel or program, the user is prevented from easily determining the direction in which scrolling or skipping is to be performed. This results in program display that is difficult for the user to understand.

Here, for example, when the user operates the program table key 17h on the remote controller 17 in order to select a program C1 from broadcasting station C, station C is contained in the electronic program table displayed using one of the available broadcasting stations which has the smallest company identification number. In this case, the cursor indicates the display area for the selected program C1 to be hatched as shown in FIG. 4. This results in display that is easy for the user to understand.

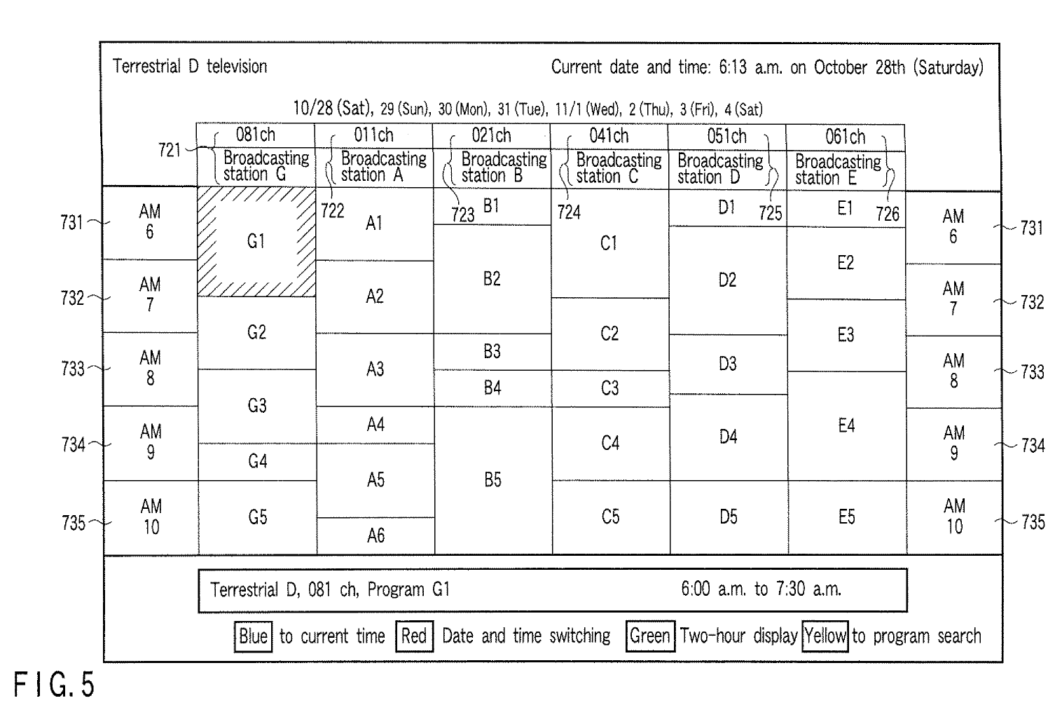

FIG. 5 shows another example of the display form of the electronic program table displayed on the video display 14 when the user operates the program table key 17h on the remote controller 17. For example, the broadcasting station selected by the user operating the program table key 17h on the remote controller 17 may not be included in the six broadcasting stations A to F initially displayed using the broadcasting station with the smallest company identification number as a start point. That is, if the user operates the program table key 17h on the remote controller 17 with a program G1 from broadcasting station G selected, broadcasting station G being not included in the six broadcasting stations A to F selected in order of increasing company identification number, then broadcasting station G is not displayed in the initial electronic program table.

In this cases as shown in FIG. 5, selected broadcasting station G is assigned to the leftmost channel display frame 721 in the electronic program table so as to enable broadcast programs G1 to G5 scheduled by broadcasting station G to be displayed. In this case, the cursor indicates the display area for the selected program G1 to be hatched as shown in FIG. 5. This results in display that is easy for the user to understand. Broadcasting stations A to E with smaller company identification numbers are sequentially assigned to the other channel display frames 722 to 726. Broadcasting station F is not displayed in the initial electronic program table.

Thus, upon displaying the electronic program table, the user can recognize future broadcast programs scheduled by currently selected broadcasting station G (channel number: 081). Furthermore, the electronic program table is always displayed with the other broadcasting stations arranged in the same order of broadcasting. This results in display that is easy for the user to understand.

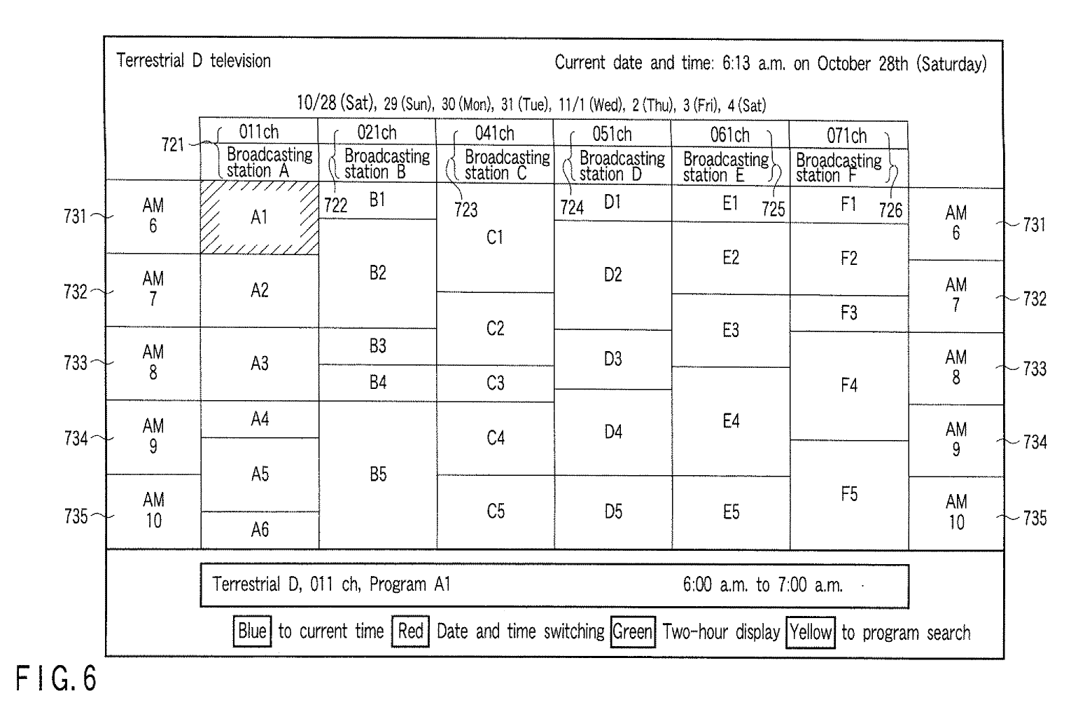

FIG. 6 shows yet another example of the display form of the electronic program table displayed on the video display 14 when the user operates the program table key 17h on the remote controller 17. That is, when the user operates the program display key 17h on the remote controller 17 to request display of the electronic program table, the electronic program table is displayed on the video display 14 in the display form using one of the available broadcasting stations which has the smallest company identification number. At this time, as shown by hatching in FIG. 6, broadcasting station A with the smallest company identification number is forcibly selected. The program A1 being broadcast is indicated by the cursor. In this case, the broadcasting station selected before the display of the electronic program table is invalidated.

In this manner, regardless of which program has been selected by the user, a request for display of the electronic program table allows broadcasting station A with the smallest company identification number to be selected, while allowing the program A1 being broadcast to be indicated by the cursor. Thus, the electronic program table is always displayed with the same order of broadcasting stations. The user can easily determine the position of the cursor. Consequently, when searching for another channel or program, the user can easily determine the direction in which scrolling or skipping is to be performed. This results in program display that is easy for the user to understand.

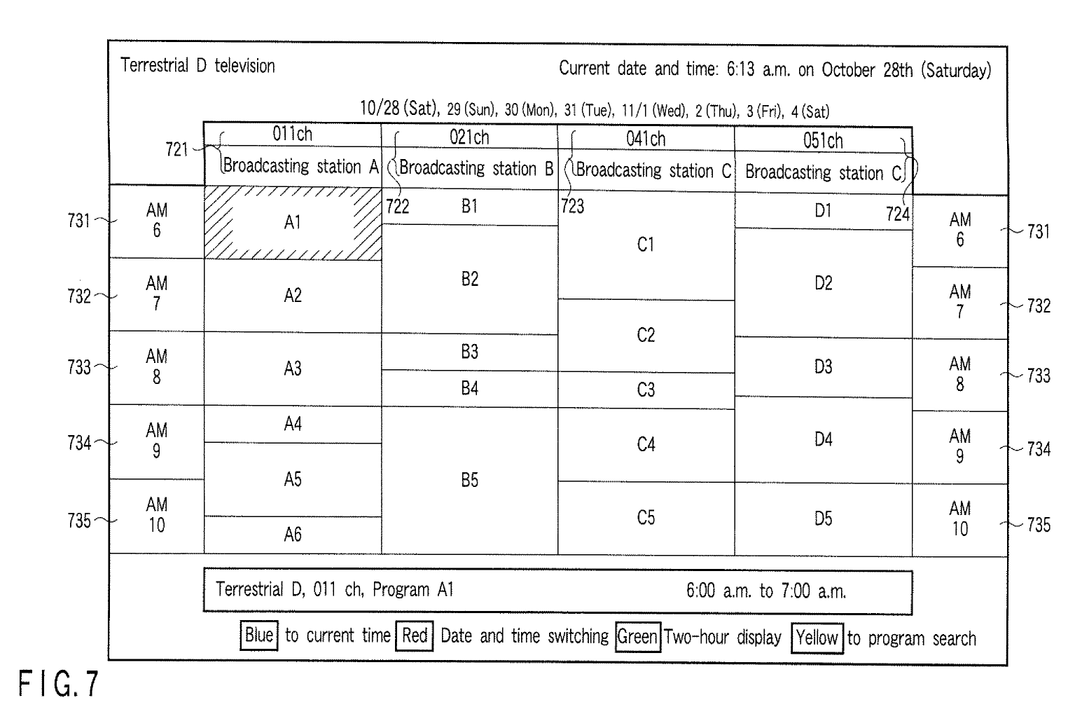

FIG. 7 shows still another example of the display form of the electronic program table displayed on the video display 14 when the user operates the program table key 17h on the remote controller 17. That is, as shown in FIG. 4, the six channel display frames 721 to 726 are arranged in the electronic program table so as to enable the six broadcasting stations to be displayed.

In contrast, if the number of available broadcasting stations is smaller than six, for example, four, then as shown in FIG. 7, the four channel display frames 721 to 724 conforming to the number of broadcasting stations are extended so that the channel display frames have an almost uniform width in a horizontal direction while covering the entire area of the electronic program table. This extends the display area for the program information for each broadcasting station, enabling, for example, an increase in the amount of information displayed and in the size of text. This results in program display that is easy for the user to understand.

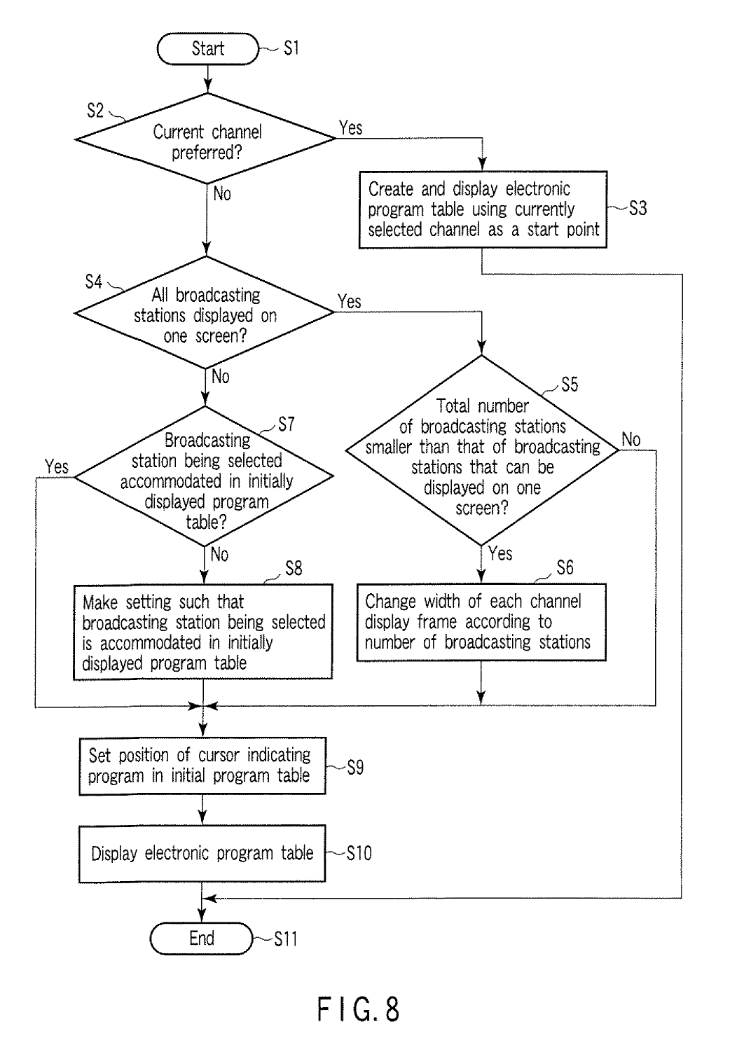

FIG. 8 is a flowchart generally illustrating a process operation of creating an electronic program table in any of the various display forms described above. That is, the process is started (step S1). Then, the program table creation control module 63e determines in step S2 whether the display form of the electronic program table is set to use the currently selected channel as a start point as in the prior art or to use the broadcasting station with the smallest company identification number as a start point as described above.

That is, with the digital television broadcast receiving apparatus 11, the user can selectively set whether the electronic program table is displayed in the display form using the currently selected channel as a start point (current channel preferred) or in the display form using the broadcasting station with the smallest company identification number as a start point (company order preferred).

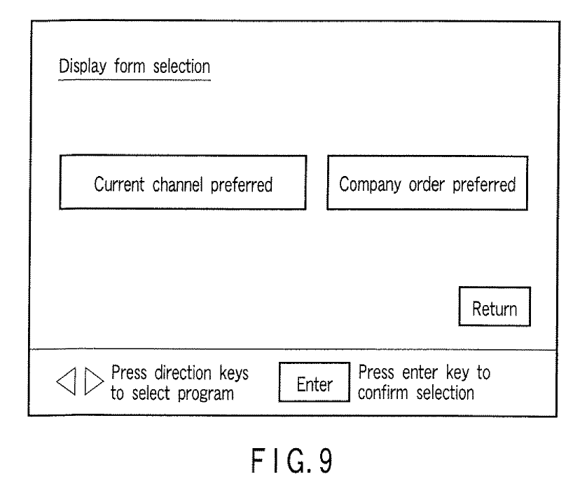

This setting can be achieved by the user operating the menu key 17p on the remote controller 17 to enter a menu screen with a layered structure to reach such a display form selection screen as shown in FIG. 9, then using the cursor key 17f to select one of an item “current channel preferred” and an item “company order preferred”, and then using the enter key 17g to confirm the selection.

if the item “current channel preferred” is selected and entered, the electronic program table is set to be displayed in the display form using the currently selected channel as a start point. If the item “company order preferred” is selected and entered, the electronic program table is set to be displayed in the display form using the broadcasting station with the smallest company identification number as a start point.

Upon determining in step S2, described above, that the current channel preferred is set (YES), the program table creation control module 63e creates and displays the electronic program table using the currently selected channel as a start point in step S3, to complete the process (step S11).

Upon determining in step 2, described above, that the company order preferred is set (NO), the program table creation control module 63e determines in step S4 whether or not all the available broadcasting stations can be displayed within the single screen of the electronic program table, that is, the number of available broadcasting stations is equal to or smaller than that (six) of channel display frames 721 to 726.

Upon determining that all the available broadcasting stations can be displayed within the single screen of the electronic program table (YES), the program table creation control module 63e determines in step S5 whether or not the number of available broadcasting stations is smaller than that of broadcasting stations that can be displayed within the single screen of the electronic program table, that is, whether or not the number of available broadcasting stations is smaller than that (six) of the channel display frames 721 to 726.

Upon determining that the number of available broadcasting stations is smaller than that of broadcasting stations that can be displayed within the single screen of the electronic program table (YES), the program table creation control module 63e changes the channel display frames the number of which is equal to that of broadcasting stations so that the channel display areas have almost a uniform width in the horizontal direction while covering the entire area of the electronic program table, in step S6, as shown in FIG. 7.

Upon determining in step S4, described above, that not all the available broadcasting stations can be displayed within the single screen of the electronic program table (NO), the program table creation control module 63e determines in step S7 whether or not the currently selected broadcasting station is accommodated in the initially displayed electronic program table. Upon determining that the currently selected broadcasting station is not accommodated in the initially displayed electronic program table (NO), the program table creation control module 63e sets the currently selected broadcasting station, which is not accommodated in the initially displayed electronic program table, so that the currently selected broadcasting station is accommodated in the initially displayed electronic program table, in step S8, as shown in FIG. 5.

Upon determining, after step S6 or S8, described above, or in step S5, described above, that the number of available broadcasting stations is not smaller than that of broadcasting stations that can be displayed within the single screen of the electronic program table, that is, the number of available broadcasting stations is the same as that (six) of the channel display frames 721 to 726 (NO), or upon determining in step S7 that the currently selected broadcasting station is accommodated in the initially displayed electronic program table (YES), the program table creation control module 63e sets the position of the cursor indicating the program in the initially displayed electronic program table in step S9. Then, in step S10, the program table creation control module 63e displays the electronic program table in the display form using the broadcasting station with the smallest company identification number as a start point, to complete the process (step S11).

In the above-described embodiment, when display of the electronic program table is requested, the broadcasting stations are described in the displayed electronic program table in order of increasing company identification number. However, the order is not limited to the company identification number. Of course, a pre-standardized company order may be adopted.

The term “pre-standardized company order” as used herein refers to, for example, the company order according to the specified order of programs arranged in a program table in a newspaper, a magazine, and the like in a particular country or region. In this case, the program table creation control module 63e functions to create and display an electronic program table in the pre-standardized order on the basis of information supplied by the signal processing module 48 and the like. Therefore, describing the broadcasting stations in this order provides an electronic program table in a display form similar to that in the newspaper, magazine, and the like.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A program display device comprising:
an acquiring module configured to acquire program information; and
a creating module configured to create an electronic program table on the basis of the program information acquired by the acquiring module, the electronic program table having a channel axis along which a plurality of broadcasting stations are arranged in one direction and a time axis arranged in a direction orthogonal to the channel axis, an area shown by the channel axis and the time axis corresponding to a display area for the program information,
wherein the creating module is configured to place the plurality of broadcasting stations arranged along the channel axis in an order based on a pre-standardized order of companies.

2. A program display device according to claim 1, wherein the creating module is configured to place the plurality of broadcasting stations arranged along the channel axis in an order based on a company identification number.

3. A program display device according to claim 1, wherein the creating module is configured to, if a selected program is present in an electronic program table initially displayed in response to a request for display, provide a display in which the program is indicated by a cursor.

4. A program display device according to claim 1, wherein the creating module is configured to provide a display in which among programs displayed in the electronic program table initially displayed in response to the request for display, the program corresponding to a preset position is indicated by a cursor.

5. A program display device according to claim 1, wherein the creating module is configured to, if a selected broadcasting station is not present in the electronic program table initially displayed in response to the request for display, place the broadcasting station in the initially displayed electronic program table.

6. A program display device according to claim 1, wherein the creating module is configured to, when the number of available broadcasting stations is smaller than that of broadcasting stations which can be displayed in the electronic program table, extend a display area corresponding to each of the broadcasting stations in the channel direction.

7. A broadcast receiving apparatus comprising:
a receiving module configured to receive a broadcast signal;
a signal processing module configured to extract a signal of a desired channel from the broadcast signal received by the receiving module and execute predetermined signal processing on the signal of the desired channel to generate a video signal;
an output module configured to output the video signal obtained by the signal processing module;
an acquiring module configured to acquire program information; and
a creating module configured to create an electronic program table on the basis of the program information acquired by the acquiring module, the electronic program table having a channel axis along which a plurality of broadcasting stations are arranged in one direction and a time axis arranged in a direction orthogonal to the channel axis, an area shown by the channel axis and the time axis corresponding to a display area for the program information,
wherein the creating module is configured to place the plurality of broadcasting stations arranged along the channel axis in an order based on a pre-standardized order of companies.

8. A program display method comprising:
acquiring program information; and
creating an electronic program table on the basis of the program information acquired by the acquiring module, the electronic program table having a channel axis along which a plurality of broadcasting stations are arranged in one direction and a time axis arranged in a direction orthogonal to the channel axis, an area shown by the channel axis and the time axis corresponding to a display area for the program information,
wherein in the creating, the plurality of broadcasting stations arranged along the channel axis are placed in an order based on a pre-standardized order of companies.
